(19) United States
(12) Patent Application Publication
(10) Pub. No.: US 2020/0120927 A1
(43) Pub. Date: Apr. 23, 2020

(54) INSECTICIDE COMPOSITION

(71) Applicant: Bettina Atley, Winfield (CA)

(72) Inventor: Bettina Atley, Winfield (CA)

(21) Appl. No.: 16/168,347

(22) Filed: Oct. 23, 2018

(51) Int. Cl. A01N 31/02; A01N 65/22; A01N 65/36; A01N 25/04

(52) U.S. Cl. CPC A01N 31/02; A01N 25/04; A01N 65/36; A01N 65/22

(57) ABSTRACT

A composition comprising a quantity of geraniol essential oil, a quantity of rosemary essential oil, a quantity of peppermint essential oil, and a quantity of grapefruit essential oil. A method for preparing a composition comprising combining a quantity of geraniol essential oil, a quantity of rosemary essential oil, a quantity of peppermint essential oil, and a quantity of grapefruit essential oil. A method for protecting a plant from insects comprising providing a composition comprising a quantity of geraniol essential oil, a quantity of rosemary essential oil, a quantity of peppermint essential oil, and a quantity of grapefruit essential oil; and applying the composition to the plant.

### BACKGROUND OF THE INVENTION

### 1. Field of Invention

The present invention relates generally to pest control and in particular to a food safe composition and method for preparing a composition operable to be applied to plants to protect them from insects.

### 2. Description of Related Art

Pests such as insects are known to cause damage and other nuisances to growers and gardeners. Such insects may damage the plants by eating a quantity of them or may otherwise interfere with a garden by walking through that region also causing damage.

Insecticides or chemicals are also frequently employed to kill or drive away some insets from eating the target plants. Disadvantageously however, many such insecticides may be toxic to animals and/or human which limits their desirability. In particular, in the case of vegetables or other consumables, it is undesirable to apply toxic chemicals to the plants which may then be ingested by people. Furthermore, in the case of flowers, it is also undesirable to apply such chemicals to the flowers at a time when they would also be consumed by pollinating bees or the like.

### SUMMARY OF THE INVENTION

According to a first embodiment of the present invention there is disclosed a composition comprising a quantity of geraniol essential oil, a quantity of rosemary essential oil, a quantity of peppermint essential oil, and a quantity of grapefruit essential oil.

The geraniol essential oil may be present in an amount between 15 and 25% by weight. The rosemary essential oil may be present in an amount between 15 and 25% by weight. The peppermint essential oil may be present in an amount between 2.5 and 7.5% by weight. The grapefruit essential oil may be present in an amount between 5 and 15% by weight.

The composition may further comprise an emulsifier. The emulsifier may comprise glyceryl monooleate. The glyceryl monooleate may be present in an amount between 10 and 20% by weight.

The composition may further comprise a carrier base oil. The carrier base oil may comprise wheatgerm oil. The wheatgerm oil may be present in an amount between 25 and 35% by weight.

The composition may further comprise a quantity of water. The quantity of water may be present in an amount greater than 90% by volume.

According to a further embodiment of the present invention there is disclosed a method for preparing a composition comprising combining a quantity of geraniol essential oil, a quantity of rosemary essential oil, a quantity of peppermint essential oil, and a quantity of grapefruit essential oil.

The method may further comprise introducing to the composition a quantity of a base carrier oil. The carrier base oil may comprise wheatgerm oil.

The method may further comprise introducing to the composition a quantity of an emulsifier. The emulsifier may comprise glyceryl monooleate. The method may further comprise mixing the composition in a quantity of water.

According to a further embodiment of the present invention there is disclosed a method for protecting a plant from insects comprising providing a composition comprising a quantity of geraniol essential oil, a quantity of rosemary essential oil, a quantity of peppermint essential oil, and a quantity of grapefruit essential oil; and applying the composition to insects on or near the plant.

The method may further comprise introducing the composition to an applicator. The applicator may comprise spraying the plant with the composition.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an illustration of a plant being applied with a composition for protecting the plant from insects according to a first embodiment of the present invention.

FIG. 2 is a flow chart depicting a method of preparing the composition for use in protecting plants from insects.

### DETAILED DESCRIPTION

The present invention provides a composition for use in killing or repelling insects from target plants or regions. The term “insect” as utilized herein includes all insects known to cause damage to plants and other crops including, such as, by way of non-limiting example, spider mites broad mites and other insects.

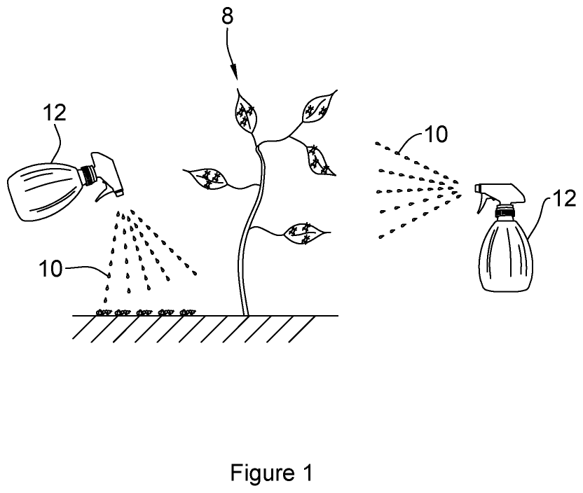

According to a first embodiment of the present invention, as illustrated in FIG. 1, a target plant 8 may be protected from being eaten by insects. As illustrated in FIG. 1, the target plant 8 may be protected by spraying or otherwise applying an insecticide composition 10 to the insects on or near the plant so as to kill or deter them. As illustrated in FIG. 1, the composition 10 may be applied to the surface of the target plant through the use of a sprayer 12, as is commonly known, or through any other known method. Optionally, the composition 10 may be applied to the soil surrounding the target plant to kill or otherwise prevent insects from entering the location of the target plant. Once applied to the plant, the composition will kill or otherwise repel insects that are undesirable.

The composition 10 includes a mixture of food grade non-toxic active and inactive ingredients selected to kill or repel insects. By way of non-limiting example, the present composition may include as active ingredients a combination of one or more of geraniol essential oil, rosemary essential oil, peppermint essential oil and grapefruit essential oil. It will also be appreciated that the composition may also include a base oil such as by way of non-limiting example, wheatgerm oil or the like and may optionally include other additives such as surfactants, preservatives or emulsifiers as will be known in the art to aid in storage or application of the composition to the target plant.

As used herein, an “essential oil” is any hydrophobic liquid containing volatile aromatic compounds from plants. They are also known as volatile or ethereal oils, or simply as the “oil of” the plant material from which they were extracted, such as oil of grapefruit. The term “essential” indicates that the oil carries distinctive scent (essence) of the plant. Essential oils are may be extracted or prepared by any known method but are typically extracted by distillation and hence may be concentrated. Other processes include expression and solvent extraction. Furthermore, as used throughout the specification the term “about” is defined as plus or minus 10% of the stated value.

### Geraniol Essential Oil

In some embodiments, the repellent compositions and formulations of the present invention may contain geraniol essential oil. Geraniol essential oil (CAS Reg. No. 106-24-1) is obtained from the Pelargonium plant by commonly known methods. According to the present invention, geraniol essential oil may be present in the compositions of the present invention from about 15% by weight to about 25% by weight, although it will be appreciated that other quantities may be utilized as well.

### Rosemary Essential Oil

In one embodiment, the compositions and formulations of the present invention may contain rosemary essential oil (CAS Reg. No. 8000-25-7) obtained from the Rosemarinus officinalis plant by commonly known methods. According to the present invention, rosemary essential oil, when present, may be present in the compositions of the present invention from about 15% by weight to about 25% by weight, although it will be appreciated that other quantities may be utilized as well.

### Peppermint Essential Oil

In some embodiments, the compositions and formulations of the present invention may contain peppermint essential oil. Peppermint essential oil (CAS Reg. No. 8006-90-4) is obtained from the Mentha-piperita L. plant by commonly known methods. According to the present invention, peppermint essential oil may be present in the compositions of the present invention from about 2.5% by weight to about 7.5% by weight, although it will be appreciated that other quantities may be utilized as well.

### Grapefruit Essential Oil

In some embodiments, the compositions and formulations of the present invention may contain grapefruit essential oil. Grapefruit essential oil (CAS Reg. No. 8016-20-4) is obtained from the peel of the Citrus paradisi plant by commonly known methods. According to the present invention, grapefruit essential oil may be present in the compositions of the present invention from about 5% by weight to about 15% by weight, although it will be appreciated that other quantities may be utilized as well.

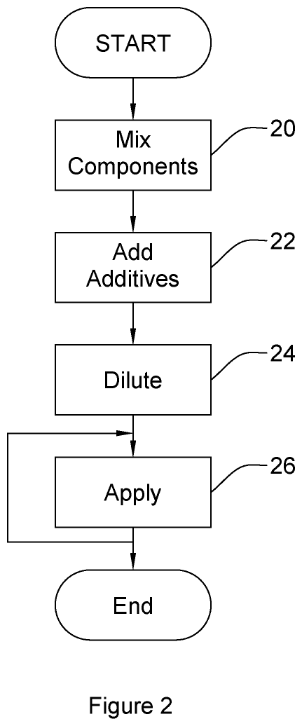

As illustrated in FIG. 2, according to one embodiment of the present invention, the composition 10 may be prepared by mixing pre-measured quantities of the active ingredients together in a container. The active ingredients may be mixed together at room temperature and atmospheric conditions and may optionally be mixed with a carrier base oil, such as, by way of non-limiting example, wheatgerm oil in step 20. Optionally, one or more additive or inactive ingredient may be added to the composition to provide one or more enhancement such as preserving the composition, stabilizing the composition or lowering the surface tension to aid application to plants, such as glyceryl monooleate or the like in step 22. It will be appreciated that such a composition will form a concentrated form of the composition which may be readily stored or transported. Prior to usage, the concentrated composition may then be diluted into a quantity prior to application to the target plant. By way of non-limiting example, the concentrated composition may be mixed in a quantity of water so as to have a concentration of up to 10% to form the resultant composition 24 for application to the target plant in step 26. It will be appreciated that the resultant composition may be reapplied to the insects deemed to be undesirable on or near the plant as frequently as necessary to prolong protection of the plant.

The following example will provide an illustration of the use of the present composition.

### Example 1

The composition was prepared in the following percentages by weight:

TABLE 1
Repellent Composition

| | Weight per 1000 mL of | |
|---|---|---|
| Component | Concentrate (grams) | |
| Wheatgerm oil | 300 | g |
| Geraniol essential oil | 200 | g |
| Rosemary essential oil | 200 | g |
| Peppermint essential oil | 50 | g |
| Grapefruit essential oil | 100 | g |
| Glyceryl monooleate | 150 | g |
| | 1.00 | kg, total weight |

The above concentrate was then diluted in water at a concentration of about 1% (in particular an amount of about 10 mL was mixed with a quantity of water to form 1 litre of diluted composition).

While specific embodiments of the invention have been described and illustrated, such embodiments should be considered illustrative of the invention only and not as limiting the invention as construed in accordance with the accompanying claims.

What is claimed is:

1. A composition comprising a quantity of geraniol essential oil, a quantity of rosemary essential oil, a quantity of peppermint essential oil, and a quantity of grapefruit essential oil.

2. The composition of claim 1 wherein said geraniol essential oil is present in an amount between 15 and 25% by weight.

3. The composition of claim 1 wherein said rosemary essential oil is present in an amount between 15 and 25% by weight.

4. The composition of claim 1 wherein said peppermint essential oil is present in an amount between 2.5 and 7.5% by weight.

5. The composition of claim 1 wherein said grapefruit essential oil is present in an amount between 5 and 15% by weight.

6. The composition of claim 1 further comprising an emulsifier.

7. The composition of claim 6 wherein said emulsifier comprises glyceryl monooleate.

8. The composition of claim 7 wherein said glyceryl monooleate is present in an amount between 10 and 20% by weight.

9. The composition of claim 1 further comprising a carrier base oil.

10. The composition of claim 9 wherein said carrier base oil comprises wheatgerm oil.

11. The composition of claim 10 wherein said wheatgerm oil is present in an amount between 25 and 35% by weight.

12. The composition of claim 1 further comprising a quantity of water.

13. The composition of claim 12 wherein said quantity of water is present in an amount greater than 90% by volume.

14. A method for preparing a composition comprising combining a quantity of geraniol essential oil, a quantity of rosemary essential oil, a quantity of peppermint essential oil, and a quantity of grapefruit essential oil.

15. The method of claim 14 further comprising introducing to said composition a quantity of a base carrier oil.

16. The method of claim 15 wherein said carrier base oil comprises wheatgerm oil.

17. The method of claim 14 further comprising introducing to said composition a quantity of an emulsifier.

18. The method of claim 17 wherein said emulsifier comprises glyceryl monooleate.

19. The method of claim 14 further comprising mixing said composition in a quantity of water.

20. A method for protecting a plant from insects comprising:
providing a composition comprising a quantity of geraniol essential oil, a quantity of rosemary essential oil, a quantity of peppermint essential oil, and a quantity of grapefruit essential oil; and
applying said composition to insects on or near the plant.

21. The method of claim 20 further comprising introducing said composition to an applicator.

22. The method of claim 21 wherein said applicator comprises spraying the plant with said composition.
